(19) United States
(12) Patent Application Publication
(10) Pub. No.: US 2004/0027484 A1
(43) Pub. Date: Feb. 12, 2004

(54) Advertisement display method of mixing, advertisement pictures with tv broadcasting pictures, mobile communication pictures and pictures of picture storage mediums

(76) Inventor: Jong-Ryul Lee, Gyeongido-Do (KR)

Correspondence Address: Morgan & Finnegan, 345 Park Avenue, New York, NY, 10154-0053, US

(21) Appl. No.: 10/343,191

(22) PCT Filed: Jul. 6, 2001
(86) PCT No.: PCT/KR01/01161

(30) Foreign Application Priority Data
Aug. 1, 2000 (KR) 2000/44587

(51) Int. Cl. H04N 7/025; H04N 7/10; H04N 7/18; H04N 7/173; H04N 7/16; H04N 7/00; H04N 11/00

(52) U.S. Cl. 348/552; 725/81; 725/32; 725/133; 725/141

(57) ABSTRACT

Disclosed herein is an advertising method for displaying an advertisement mixed with an image for television broadcasting, mobile communication terminals or image storage media Images for wired/wireless television broadcasting, mobile communication terminals and image storage media are generated. A character and/or image advertisement to he mixed with the images for television broadcasting, mobile communication terminals and image storage media as part of the images is generated. The character and/or image advertisement is partially mixed with a specific image selected as one of the images for television broadcasting, mobile communication terminals and image storage media. The image partially mixed with the character and/or image advertisement is displayed on a supervisor output image monitor.

### TECHNICAL FIELD

The present invention relates generally to advertising methods, and more particularly to an advertising method for displaying an advertisement mixed with an image for television broadcasting, mobile communication terminals or image storage media.

### BACKGROUND ART

Generally, in advertising methods using various kinds of wired/wireless television (TV) broadcasting via the Internet, wireless data communication networks and satellite communication networks, personal mobile communication networks such as Internet Mobile Telecommunication (IMT) 2000, and image storage media for distribution such as movie films, video tapes, compact discs (CDs), Digital Versatile Discs (DVDs) and Video On Demands (VODs), an additionally-produced advertising image should be displayed on a TV monitor or liquid crystal display (LCD) panel for a predetermined period of time while TV images (programs) during regular broadcasting, images displayed on the LCD panel of a mobile communication terminal connected to the mobile communication network, or images displayed when a video tape is replayed are temporarily interrupted.

However, the conventional advertising methods for separately providing advertising images while temporarily interrupting regular images are disadvantageous in that an advertising time for displaying the advertising images is limited to a short range, thereby preventing an advertiser from sufficiently and continuously deriving as much advertising effect as he wants.

### DISCLOSURE OF THE INVENTION

Accordingly, the present invention has been made keeping in mind the above problems occurring in the prior art, and an object of the present invention is to provide an advertising method for displaying an advertisement mixed with an image for television broadcasting, mobile communication terminals or image storage media, which displays the image partially mixed with the character and/or image advertisement on an output image monitor, a TV monitor, or the LCD panel of a mobile communication terminal, thus allowing the advertisement together with the image to be provided to a user without interruption.

In order to accomplish the above object, the present invention provides an advertising method for displaying an advertisement mixed with an image for television broadcasting, mobile communication terminals, or image storage media comprising the steps of generating images for wired/wireless television broadcasting, mobile communication terminals and image storage media; generating character and/or image advertisement to be mixed with the images for television broadcasting, mobile communication terminals and image storage media as part of the images; partially mixing the character and/or image advertisement with a specific image selected as one of the images for television broadcasting, mobile communication terminals and image storage media; and displaying the image partially mixed with the character and/or image advertisement on a supervisor output image monitor, transmitting the image mixed with the advertisement through an additional image transmitter in a wired/wireless manner, such that the image mixed with the advertisement can be displayed on a TV monitor and the liquid crystal display (LCD) panel of a mobile communication terminal, thus allowing the advertisement together with the image to be provided in real time to TV viewers and mobile communication terminal users, or transmitting the image mixed with the advertisement to a video recorder to record the advertisement-mixed image in a image storage medium for distribution, such that the advertisement together with the image is provided to users by displaying the image partially mixed with the character and/or image advertisement on the TV monitor when image storage medium users replay the image recorded in the image storage medium.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the construction of a system for performing an advertising method according to the present invention;

FIG. 2 is a flowchart of the advertising method of the present invention;

FIG. 3 is a flowchart of an advertisement generating method of FIG. 2;

FIG. 4 is a flowchart of an advertisement mixing method of FIG. 2; and

FIG. 5 is a flowchart of an advertisement displaying method of FIG. 2.

### BEST MODE FOR CARRYING OUT THE INVENTION

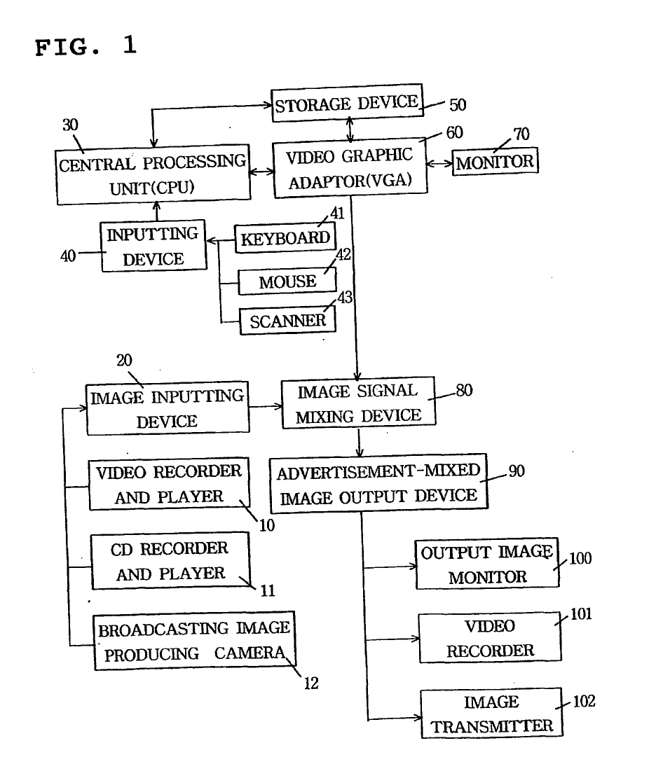

Referring to FIG. 1, in the system for performing an advertising method according to the present invention, a video recorder and player 10, a CD recorder and player 11 and a broadcasting image producing camera 12 each output video signals for generating images (hereinafter, referred to as regular images) for wired/wireless TV broadcasting, mobile communication terminals and image storage media.

An image signal inputting device 20 converts the video signals into composite video signals or S-video signals, such that the regular images actually required are generated.

A central processing unit (CPU) 30 sets an X-Y coordinate system on an entire display screen according to the resolution of a display device for actually displaying the regular images.

The CPU 30 displays an advertisement editing screen on a monitor 70 connected to a video graphic adaptor (VGA) 60 by executing an advertisement editing program pre-stored in a storage device 50 when a character and/or image advertisement editing request signal and an editing signal generated by supervisor operating an inputting device 40 such as a keyboard 41, a mouse 42 and a scanner 43 are applied. Additionally, the CPU 30 stores character and/or image advertisement having been edited by the supervisor in the storage device 50.

The image signal mixing device 80 mixes the character and/or image advertisement inputted via the storage device 50 and the video graphic adaptor 60 with some of the regular images inputted through the image signal inputting device 20 if an advertisement display command is applied under the control of the CPU 30.

At this time, the CPU 30 designates initial display coordinates according to the size of the character and/or image advertisement on the basis of the X-Y coordinate system, and further designates the moving direction, moving interval, temporary stopping time and moving limit coordinates of each advertisement displayed on a regular image to be mixed with the advertisement.

An advertisement-mixing image outputting device 90 displays the regular image partially mixed with the character and/or image advertisement on a supervisor output image monitor 100, such that the supervisor confirms the image outputting state, and transmits the regular image mixed with the advertisement through an image transmitter 102 in a wired/wireless manner, such that the regular image mixed with the advertisement can be displayed on a TV monitor (not shown) and the LCD panel (not shown) of the mobile communication terminal, thus allowing the advertisement together with the regular image to be provided to TV viewers and mobile communication terminal users in real time.

The advertisement-mixed image output device 90 transmits the regular image mixed with the advertisement to a video recorder 101 to record the regular image mixed with the advertisement in an image storage medium for distribution.

The advertisement-mixed regular image stored in the image storage medium is displayed together with the character and/or image advertisement mixed as part of the replayed image on the user's TV monitor (not shown) when the user replays the image stored in the image storage medium for distribution. At this time, the advertisement with the regular image can also be continuously provided to users.

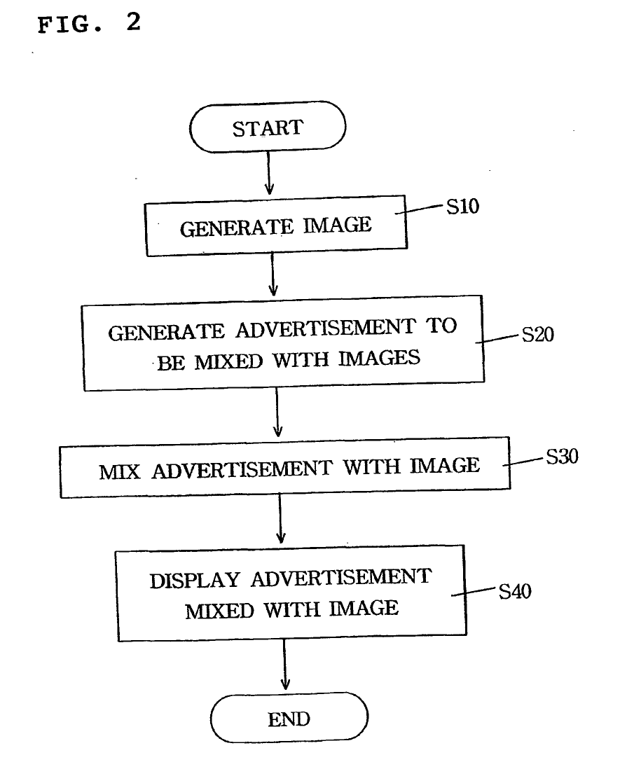

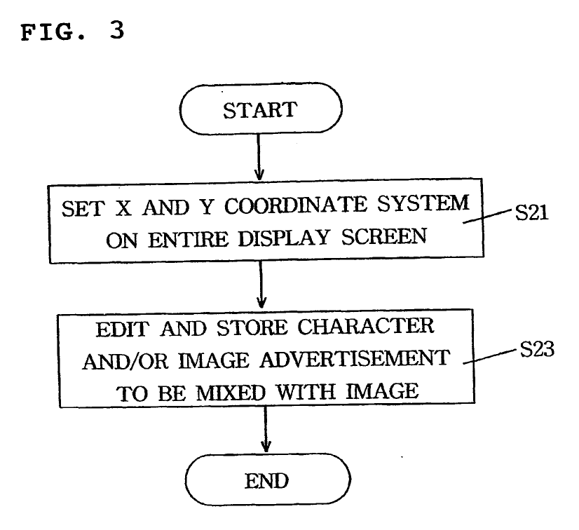

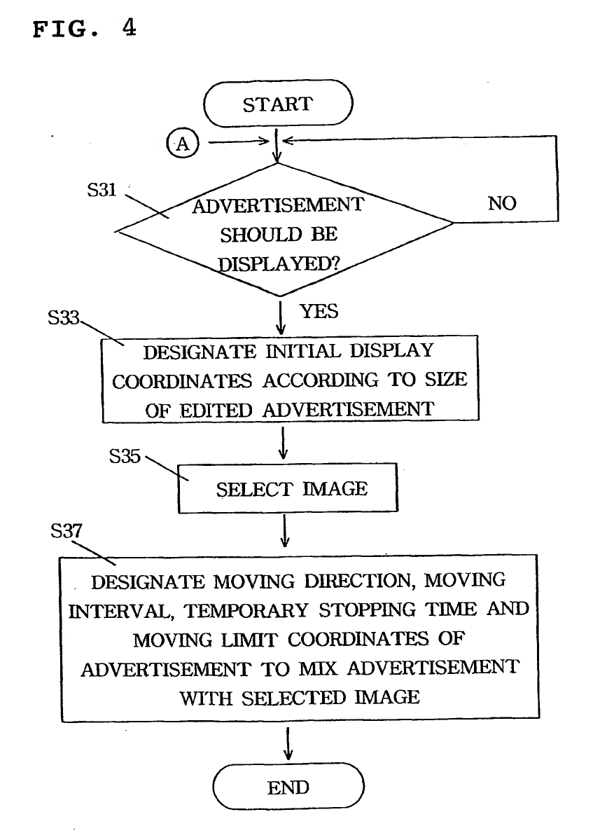

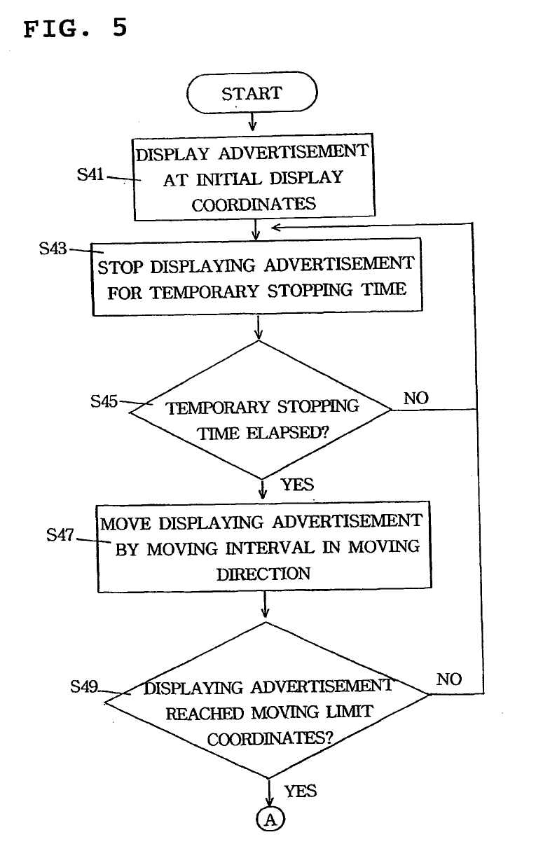

The system having the above construction for performing the advertising method mixes the advertisement with an image for TV broadcasting, mobile communication terminals or image storage media to display the advertisement-mixed image according to advertising methods of FIGS. 2 to 5.

First, when the supervisor generates video signals for producing regular images, in other words, images for wired/wireless TV broadcasting, mobile communication terminals and image storage media using the video recorder and player 10, the CD recorder and player 11 and the broadcasting image producing camera 12, the video signals are converted into composite video signals or S-video signals by the image signal inputting device 20, such that the video signals are generated as actually required regular images at step S10.

As described above, after regular images classified into images for TV broadcasting, mobile communication terminals and image storage media for distribution are generated, the supervisor generates the character and/or image advertisement to be mixed and displayed as part of the regular images at step S20.

At step S20, the CPU 30 first sets the X-Y coordinate system on the entire display screen according to the resolution of a display device for actually displaying the regular images, for example, the TV monitor and the LCD panel of the mobile communication terminal at step S21.

Providing that the resolution of the display screen is 720×480, the X coordinate value of the X-Y coordinate system is set as 0≦X≦719 and the Y coordinate value is set as 0≦Y≦479.

Next, the CPU 30 displays the advertisement editing screen on the monitor 70 connected to the video graphic adaptor 60 by executing the advertisement editing program pre-stored in the storage device 50 if both the character and/or image advertisement editing request signal and the editing signal generated by operating the input device 40 such as the keyboard 41, the mouse 42 and the scanner 43 by the supervisor are applied, such that the supervisor may perform character and/or image advertisement editing operations. At this time, the character and/or image advertisement having been edited by the supervisor is stored in the storage device 50 at step S23.

As described above, after both the regular images and the character and/or image advertisement are generated, the CPU 30 controls the image signal mixing device 80 to mix the character and/or image advertisement with a specific image selected as one of the regular images for TV broadcasting, mobile communication terminals and image storage media for distribution, as part of the specific image according to a request from the supervisor at step S30.

At step S30, the CPU 30 determines whether an advertisement display command has been applied according to the supervisor's request at step S31. If it is determined that the advertisement display command has been applied, the CPU 30 designates initial display coordinates of the character and/or image advertisement having been edited by the supervisor according to each advertisement size on the basis of the X-Y coordinate system at step S33.

In this case, because the well known minimum size of a character is a unit of 8×8 pixels, the initial display coordinates of a specific character advertisement designated according to the size of the character advertisement based on the X-Y coordinate system are designated as character coordinates with row and column values of the X-Y coordinate system, in other words, as a form of (row, column). Here, the row value is the Y coordinate value, and the column value is the X coordinate value.

For example, a character advertisement “COCA_COLA” composed of a total of nine characters has a size of 8×72 pixels. Then, if the initial display coordinates are set as (7, 71), the character advertisement “COCA_COLA” is displayed to have a height of eight rows from first to eighth rows and a length of seventy two columns from first to seventy-second columns in the upper left corner of the screen on which the regular images are displayed.

On the other hand, the initial display coordinates designated according to the size of the image advertisement are designated as image coordinates with row and column values of the X-Y coordinates system, in other words, as a form of (row, column, row, column). Here, the row value is the Y coordinate value, and the column value is the X coordinate value. Further, the column and row values of the first part of the image coordinates are start coordinates representing the height and length of the image advertisement, while the column and row values of the last part thereof are end coordinates representing the height and length of the image advertisement.

For example, if the initial display coordinates of a specific image advertisement having a size of 5×30 pixels are set as (1, 1, 5, 30), the image advertisement is displayed as an image advertisement having a height of five rows from second to sixth rows and a length of thirty columns from second to thirty-first columns in the upper left corner of the screen on which the regular images are displayed.

Next, after the initial display coordinates of the character and/or image advertisement are designated, the CPU 30 selects a specific regular image among the regular images for TV broadcasting, mobile communication terminals and image storage media for distribution at step S35. Then, the CPU 30 designates the moving direction, moving interval, temporary stopping time and moving limit coordinates of the advertisement displayed on the specific regular image to be mixed with the advertisement, such that the image signal mixing device 80 mixes the character and/or image advertisement inputted via the storage device 50 and the video graphic adaptor 60 with part of the regular image inputted through the image signal inputting device 20 when an advertisement display command is applied at step S37.

At this time, each moving direction of the advertisement to be mixed with the selected specific regular image is selectively designated among the directions from upper left to upper right, from upper right to upper left, from upper right to lower right, from lower right to upper left, from lower right to lower left, from lower left to lower right, from lower left to upper right, and from upper right to lower left with respect to the X-Y coordinate system of the entire screen.

Further, the moving limit coordinates of the character and/or image advertisement designated in their moving directions are designated as X or Y value of the X-Y coordinate system on the entire screen according to the initial display coordinates and the moving interval designated on the basis of the size of the character and/or image advertisement.

After the character and/or image advertisement is mixed as part of the regular image as described above, the advertisement-mixed image output device 90 displays the regular image partially mixed with the character and/or image advertisement on the supervisor output image monitor 100, such that the supervisor confirms the image outputting state. Further, the advertisement-mixed image output device 90 transmits the regular image mixed with the advertisement through the image transmitter 102 in a wired/wireless manner, such that the regular image mixed with the advertisement can be displayed on both the TV monitor (not shown) and the LCD panel (not shown) of the mobile communication terminal, thus allowing the advertisement together with the regular image to be provided in real time to TV viewers and mobile communication terminal users.

Moreover, the advertisement-mixed image output device 90 also transmits the regular image mixed with the advertisement to the video recorder 101 to record the regular image mixed with the advertisement in the image storage medium for distribution, such that when the user replays the image recorded in the image storage medium for distribution, the character and/or image advertisement mixed with the regular image is displayed on the user's TV monitor (not shown) at step S40.

At step S40, the process of actually displaying the advertisement mixed with the regular image is described in detail.

a) First, the process of displaying the character advertisement together with the regular image while moving the character advertisement mixed with the regular image from upper left to upper right on the display screen is described as follows.

For example, if the moving direction of the character advertisement 15 “COCA_COLA” having initial display coordinates of (7,71) and the size of 8×72 pixels on the basis of the X-Y coordinate system on a display screen with a resolution of 720×480 is set as the direction from upper left to upper right, and the moving interval is set as+80 columns, the moving limit coordinates of the character advertisement “COCA_COLA” are set from a value obtained by subtracting 72 columns from total 720 columns, in other words, as X≦648 because the total length of the character advertisement “COCA_COLA” corresponds to 72 columns.

Therefore, after the character advertisement “COCA_COLA” is displayed at the initial display coordinates (7,71) in the upper left part of the regular image at step S41, the character advertisement is temporarily stopped for the temporary stopping time preset by the CPU 30 at step S43. After the temporary stopping time elapses at step S45, the character advertisement is moved by the interval of 80 columns from upper left to upper right of the screen on which the regular image is displayed at step S47.

The movement of the character advertisement “COCA_COLA” is repeatedly performed until the start position of the characters “COCA_COLA” reaches the moving limit coordinates as X≦648, and if the character advertisement reaches the moving limit coordinates, the advertisement-mixed image output device 90 returns to the step S31 for determining whether the advertisement should be displayed in the advertisement mixing step S30 to repeatedly perform the advertisement mixing and displaying procedures under the control of the CPU 30 at step S49.

b) The process of displaying the character advertisement together with the regular image while moving the character advertisement mixed with the regular image from upper right to upper left on the display screen is described as follows.

For example, if the moving direction of the character advertisement “COCA_COLA” having initial display coordinates of (7, 648) and the size of 8×72 pixels is set as the direction from upper right to upper left, and the moving interval is set as −80 columns, the moving limit coordinates of the character advertisement “COCA_COLA” are set as X≦5.

Therefore, after the character advertisement “COCA_COLA” is displayed at the initial display coordinates (7, 648) in the upper right part of the regular image at step S41, the character advertisement is temporarily stopped for the temporary stopping time preset by the CPU 30 at step S43. After the temporary stopping time elapses at step S45, the character advertisement is moved by the interval of −80 columns from upper right to upper left of the screen on which the regular image is displayed at step S47.

The movement of the character advertisement “COCA_COLA” is repeatedly performed until the start position of the characters “COCA_COLA” reaches the moving limit coordinates X≦0, and if the character advertisement reaches the moving limit coordinates, the advertisement-mixed image output device 90 returns to the step S31 for determining whether the advertisement should be displayed in the advertisement mixing step S30 to repeatedly perform the advertisement mixing and displaying procedures under the control of the CPU 30 at step S49.

c) The process of displaying the character advertisement together with the regular image while moving the character advertisement mixed with the regular image from upper right to lower right on the display screen is described as follows.

For example, if the moving direction of the character advertisement “COCA_COLA” having initial display coordinates of (7,648) and the size of 8×72 pixels is set as the direction from upper right to lower right, and the moving interval is set as+20 rows, the moving limit coordinates of the character advertisement “COCA_COLA” are set from a value obtained by subtracting 8 rows from total 480 rows, in other words, as Y≦472 because the height of the character advertisement “COCA_COLA” corresponds to 8 rows.

Therefore, after the character advertisement of “COCA_COLA” is displayed at the initial display coordinates (7, 648) in the upper right part of the regular image at step S41, the character advertisement is temporarily stopped for the temporary stopping time preset by the CPU 30 at step S43. After the temporary stopping time elapses at step S45, the character advertisement is moved by the interval of +20 rows from upper right to lower right of the screen on which the regular image is displayed at step S47.

The movement of the character advertisement “COCA_COLA” is repeatedly performed until the start position of the character “COCA_COLA” reaches the moving limit coordinates Y≦472, and if the character advertisement reaches the moving limit coordinates, the advertisement-mixed image output device 90 returns to the step S31 for determining whether the advertisement should be displayed in the advertisement mixing step S30 to repeatedly perform the advertisement mixing and displaying procedures under the control of the CPU 30 at step S49.

d) The process of displaying the character advertisement together with the regular image while moving the character advertisement mixed with the regular image from lower right to upper right on the display screen is described as follows.

For example, if the moving direction of the character advertisement “COCA_COLA” having initial display coordinates of (472, 648) and the size of 8×72 pixels is set as the direction from lower right to upper right, and the moving interval is set as −20 rows, the moving limit coordinates of the character advertisement “COCA_COLA” are set as Y≦0.

Therefore, after the character advertisement of “COCA_COLA” is displayed at the initial display coordinates (472, 648) in the lower right part of the regular image at step S41, the character advertisement is temporarily stopped for the temporary stopping time preset by the CPU 30 at step S43. After the temporary stopping time elapses at step S45, the character advertisement is moved by the interval of −20 rows from lower right to upper right of the screen on which the regular image is displayed at step S47.

The movement of the character advertisement “COCA_COLA” is repeatedly performed until the start position of the character “COCA_COLA” reaches the moving limit coordinates Y≦0, and if the character advertisement reaches the moving limit coordinates, the advertisement-mixed image output device 90 returns to the step S31 for determining whether the advertisement should be displayed in the advertisement mixing step S30 to repeatedly perform the advertisement mixing and displaying procedures under the control of the CPU 30 at step S49.

e) The process of displaying the image advertisement together with the regular image while moving the image advertisement mixed with the regular image from upper left to upper right on the display screen is described.

For example, when the moving direction of the image advertisement having initial display coordinates of (1, 1, 5, 30) and the size of 5×30 pixels is set as the direction from upper left to upper right and the moving interval is set as +40 columns, the moving limit coordinates of the image advertisement are set from a value obtained by subtracting 31 columns from total 720 columns, in other words, as X≦689 because the length of the image advertisement corresponds to 30 columns and the image advertisement is displayed from the second column.

Therefore, after the image advertisement is displayed at the initial display coordinates (1, 1, 5, 30) in the upper left part of the regular image at step S41, the image advertisement is temporarily stopped for the temporary stopping time preset by the CPU 30 at step S43. After the temporary stopping time elapses at step S45, the image advertisement is moved by the interval of +40 columns from upper left to upper right of the screen on which the regular image is displayed at step S47.

The movement of the image advertisement is repeatedly performed until the start position of the image advertisement reaches the moving limit coordinates as X≦689, and if the image advertisement reaches the moving limit coordinates, the advertisement-mixed image output device 90 returns to the step S31 for determining whether the advertisement should be displayed in the advertisement mixing step S30 to repeatedly perform the advertisement mixing and displaying procedures under the control of the CPU 30 at step S49.

f) The process of displaying the image advertisement together with the regular image while moving the image advertisement mixed with the regular image from upper right to upper left on the display screen is described.

For example, if the moving direction of the image advertisement having initial display coordinates of (1, 689, 5, 719) and the size of 5×30 pixels is set as the direction from upper right to upper left and the moving interval is set as −40 columns, the moving limit coordinates of the image advertisement are set as X≦0.

Therefore, after the image advertisement is displayed at the initial display coordinates (1, 689, 5, 719) in the upper right part of the regular image at step S41, the image advertisement is temporarily stopped for the temporary stopping time preset by the CPU 30 at step S43. After the temporary stopping time elapses at step S45, the image advertisement is moved by the interval of −40 columns from upper right to upper left of the screen on which the regular image is displayed at step S47.

The movement of the image advertisement is repeatedly performed until the start position of the image advertisement reaches the moving limit coordinates X≦0, and if the image advertisement reaches the moving limit coordinates, the advertisement-mixed image output device 90 returns to the step S31 for determining whether the advertisement should be displayed in the advertisement mixing step S30 to repeatedly perform the advertisement mixing and displaying procedures under the control of the CPU 30 at step S49.

g) The process of displaying the image advertisement together with the regular image while moving the image advertisement mixed with the regular image from upper right to lower right on the display screen is described.

For example, if the moving direction of the image advertisement having initial display coordinates of (1, 689, 5, 719) and the size of 5×30 pixels is set as the direction from upper right to lower right and the moving interval is set as +10 rows, the moving limit coordinates of the image advertisement are set from a value obtained by subtracting 6 rows from total 480 rows, in other words, as Y≦474 because the height of the image advertisement corresponds to 5 rows and the image advertisement is displayed from the second row.

Therefore, after the image advertisement is displayed at the initial display coordinates (1, 689, 5, 719) in the upper right part of the regular image at step S41, the image advertisement is temporarily stopped for the temporary stopping time preset by the CPU 30 at step S43. After the temporary stopping time elapses at step S45, the image advertisement is moved by the interval of +10 rows from upper right to lower right of the screen on which the regular image is displayed at step S47.

The movement of the image advertisement is repeatedly performed until the start position of the image advertisement reaches the moving limit coordinates as Y≦474, and if the image advertisement reaches the moving limit coordinates, the advertisement-mixed image output device 90 returns to the step S31 for determining whether the advertisement should be displayed in the advertisement mixing step S30 to repeatedly perform the advertisement mixing and displaying procedures under the control of the CPU 30 at step S49.

h) The process of displaying the image advertisement together with the regular image while moving the image advertisement mixed with the regular image from lower right to upper right on the display screen is described.

For example, if the moving direction of the image advertisement having initial display coordinates of (474, 689, 479, 719) and the size of 5×30 pixels is set as the direction from lower right to upper right and the moving interval is set as 10 rows, the moving limit coordinates of the image advertisement are set as Ys 0.

Therefore, after the image advertisement is displayed at the initial display coordinates (474, 689, 479, 719) in the lower right part of the regular image at step S41, the image advertisement is temporarily stopped for the temporary stopping time preset by the CPU 30 at step S43. After the temporary stopping time elapses at step S45, the image advertisement is moved by the interval of −10 rows from lower right to upper right of the screen on which the regular image is displayed at step S47.

The movement of the image advertisement is repeatedly performed until the start position of the image advertisement reaches the moving limit coordinates Y≦0, and if the image advertisement reaches the moving limit coordinates, the advertisement-mixed image output device 90 returns to the step S31 for determining whether the advertisement should be displayed in the advertisement mixing step S30 to repeatedly perform the advertisement mixing and displaying procedures under the control of the CPU 30 at step S49.

Further, the present invention can display character and/or image advertisement mixed with regular image while moving the character and/or image advertisement in directions from lower left to lower right, from lower right to lower left, from upper left to lower left, and from lower left to upper left on the display screen, using a method similar to the above processes a) to h).

Further, the present invention can display character and/or image advertisement mixed with regular image while clockwisely moving the advertisement mixed with the regular image from the upper left to the upper right, lower right, lower left and back to the upper left, in order, on the display screen according to a method for actually setting the moving direction of the advertisement mixed with a specific regular image. Furthermore, the present invention can display the character and/or image advertisement mixed with the regular image while counterclockwisely moving the advertisement mixed with the regular image from the upper left to the lower left, lower right, upper right, and back to the upper left, in order, on the display screen according to the moving direction setting method.

Similarly, the present invention can display character and/or image advertisement mixed with the regular image while reciprocating the character and/or image advertisement mixed with the regular image left and right at the upper or lower part on the display screen, or reciprocating the advertisement up and down at the left or right part according to the method for setting the moving direction of the advertisement mixed with the specific regular image.

### INDUSTRIAL APPLICABILITY

As described above, the present invention provides an advertising method for displaying an advertisement mixed with an image for television broadcasting, mobile communication terminals or image storage media, which displays the image partially mixed with character and/or image advertisement on an output image monitor, a TV monitor and the LCD panel of a mobile communication terminal, thus enabling the advertisement together with the image to be provided to users. Therefore, the present invention is advantageous in that it can continuously provide various commercial advertisements together with regular images to normal users using various kinds of wired/wireless TV broadcasting via the Internet, wireless data communication networks and satellite communication networks, personal mobile communication networks such as IMT 2000, and image storage media for distribution such as movie films, video tapes, CDs, DVDs and VODs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An advertising method for displaying an advertisement mixed with an image for television broadcasting, mobile communication terminals or image storage media, comprising the steps of:
generating images for wired/wireless television broadcasting, mobile communication terminals and image storage media;
generating character and/or image advertisement to be mixed with the images for television broadcasting, mobile communication terminals and image storage media as part of the images;
partially mixing the character and/or image advertisement with a specific image selected as one of the images for television broadcasting, mobile communication terminals and image storage media; and
displaying the image partially mixed with the character and/or image advertisement on a supervisor output image monitor, transmitting the image mixed with the advertisement through an additional image transmitter in a wired/wireless manner, such that the image mixed with the advertisement can be displayed on a TV monitor and the liquid crystal display (LCD) panel of a mobile communication terminal, thus allowing the advertisement together with the image to be provided in real time to TV viewers and mobile communication terminal users, or transmitting the image mixed with the advertisement to a video recorder to record the advertisement-mixed image in a image storage medium for distribution, such that the advertisement together with the image is provided to users by displaying the image partially mixed with the character and/or image advertisement on the TV monitor when image storage medium users replay the image recorded in the image storage medium.

2. The advertising method according to claim 1, wherein the character and/or image advertisement generating step includes the steps of:
setting an X-Y coordinate system on an entire display screen according to resolutions of the TV monitor and the LCD panel of the mobile communication terminal for actually displaying the images for the TV broadcasting, mobile communication terminals and the image storage media; and
editing the character and/or image advertisement to be mixed with the images for TV broadcasting, mobile communication terminals and image storage media as part of the images, and storing the edited result.

3. The advertising method according to claim 1, wherein the character and/or image advertisement mixing step includes the steps of:
determining whether the advertisement should be displayed, and selecting a specific image to be mixed with the advertisement;
designating initial display coordinates according to the size of the advertisement; and
designating the moving direction, moving interval, temporary stopping time and moving limit coordinates of the advertisement to be mixed with the selected specific image so as to mix the advertisement with the selected image.

4. The advertising method according to claim 3, wherein the moving direction of the advertisement to be mixed with the selected specific image is selectively designated among directions from upper left to upper right, from upper right to upper left, from upper right to lower right, from lower right to upper left, from lower right to lower left, from lower left to lower right, from lower left to upper right, and from upper right to lower left with respect to the X-Y coordinate system of the entire screen.

5. The advertising method according to claim 4, wherein the moving interval and the moving limit coordinates of the advertisement designated in its moving direction are each designated as X or Y coordinate values of the X-Y coordinate system on the entire screen according to the initial display coordinates based on the size of the advertisement.

6. The advertising method according to claim 1, wherein the step for displaying the image mixed with the advertisement on the supervisor output image monitor, the TV monitor and the LCD monitor of the mobile communication terminal to provide the image mixed with the advertisement to the user, includes the steps of:
displaying the advertisement mixed with the image at the initial display coordinates;
stopping the displayed advertisement for a temporary stopping time set with respect to the advertisement; and
repeatedly performing the operation of moving the displayed advertisement by a predetermined moving interval in the designated direction of the advertisement until the displayed advertisement reach the designated moving limit coordinates after the temporary stopping time elapses, and returning .to the step for determining whether the advertisement should be displayed of the advertisement mixing step if the displayed advertisement reach the moving limit coordinates.
